(19) United States
(12) Patent Application Publication
(10) Pub. No.: US 2025/0131322 A1
(43) Pub. Date: Apr. 24, 2025

(54) CLIENT-CUSTOM E-GREEDY ADAPTIVE TUNING FOR FEDERATED REINFORCEMENT LEARNING

(71) Applicant: Dell Products L.P., Round Rock, TX (US)

(72) Inventors: Claudio Romero, Rio de Janeiro – RJ (BR); Eduardo Vera Sousa, Niterói – RJ (BR); Jonathan Mendes De Almeida, Brasília – DF (BR); Julia Drummond Noce, Rio de Janeiro – RJ (BR); Yanexis Pupo Toledo, Niterói – RJ (BR)

(21) Appl. No.: 18/490,684

(22) Filed: Oct. 19, 2023

(51) Int. Cl. G06N 20/00

(52) U.S. Cl. CPC G06N 20/00

(57) ABSTRACT

One example method includes receiving, by a server from each client in a group of clients, metrics and parameters of local models relating to training of a model by the client, aggregating, by the server, the model parameters, determining, by the server using the metrics that have been sent, if a convergence criterion for the model has been met, and when the convergence criterion is determined not to have been met, calculating, by the server, a respective ε value for each of the clients, and transmitting, by the server to the clients, the respective ε values, and the ε values respectively indicate, to the clients, an extent to which the client should perform exploration, and/or exploitation, in a next training round for the model.

### FIELD OF THE INVENTION

Embodiments of the present invention generally relate to federated reinforcement learning (FRL). More particularly, at least some embodiments of the invention relate to systems, hardware, software, computer-readable media, and methods for, a scheme that considers, and enables the modification of, the performance of individual clients in connection with a federated learning process concerning a model deployed at the clients.

### BACKGROUND

Reinforcement Learning (RL) is a branch of artificial intelligence that deals with sequential decision-making in dynamic environments. The objective of RL is to train an agent to learn an action policy that maximizes the accumulated rewards over time. In this case, the RL algorithm must reach a balance between exploration and exploitation. Exploration refers to taking random actions to discover new paths and gain new information about the environment, while exploitation refers to taking the best-known actions to maximize rewards. The ε-greedy adjustment is a strategy commonly used in RL to achieve this balance, where an agent selects the action with the highest estimated reward most of the time (exploitation) and, occasionally, chooses a random action with probability ε (exploration). The probability ε controls the balance between exploration and exploitation, where a high value of a results in more exploration, while a low value of ε results in more exploitation.

In Federated Reinforcement Learning (FRL) the ε-greedy tuning presents challenges due to the distributed and heterogeneous nature of client environments in federated training. FRL is an extension of RL, which deals with distributed and decentralized scenarios by distributing computational load while achieving high performance policies in less time and promoting greater guarantees of data privacy. In this case, the ε-greedy adjustment in the FRL is much more challenging than in classic RL, due to the heterogeneity of the environments, given that several clients are learning a global model in different environments.

To ensure that each client gets the best policies in their local environment and does not get stuck in local maximums in such heterogeneous scenarios, it may be necessary to customize, on a client basis, the adjustment between exploration and exploitation, but while doing so in a way that optimizes a global policy. In this context, various problems are presented in FRL approaches that employ heterogeneous and dynamic agents.

One such problem is that the FRL stopping condition is usually given by a fixed parameter that does not always guarantee training efficiency or the global policy convergence. Another problem is that each agent has its own local exploration policy (ε-greedy), which can lead to a suboptimal global model. Finally, the evaluation of the global model generally does not represent the diversity of the various local environments.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example edge-cloud federated learning process.

FIG. 2 discloses an algorithm for implementing federated learning.

FIG. 3 discloses a representation of an RL (reinforcement learning) task.

FIG. 4 discloses an example Q-learning algorithm.

FIG. 5 discloses an example HFRL (horizontal federated reinforcement learning) approach.

FIG. 6 discloses an algorithm for FRL with client-customized ε-greedy adaptive tuning.

FIG. 7 discloses an example FRL use case.

FIG. 8 discloses an algorithm for parameterization of server test environments.

FIG. 9 discloses an example method.

FIG. 10 discloses an example computing entity operable to perform any of the disclosed methods, processes, and operations.

### DETAILED DESCRIPTION OF SOME EXAMPLE EMBODIMENTS

Embodiments of the present invention generally relate to federated reinforcement learning (FRL). More particularly, at least some embodiments of the invention relate to systems, hardware, software, computer-readable media, and methods for, a scheme that considers, and enables the modification of, the performance of individual clients in connection with a federated learning process concerning a model deployed at the clients.

One example embodiment comprises a method for client-custom ε-greedy adaptive tuning for FRL, where the method may be performed in a central server-client (multiple) environment. A result of performance of the method may be the creation/modification of a model, such as a machine learning (ML) model, that takes into account conditions at each client, while also adequately generalizing to the overall environment.

Initially, in the example method, information is obtained concerning the performance of the model at each client. Thus, a respective agent at each client locally stores metrics for each model training episode completed by the client. These metrics are then sent by the agents, along with local model parameters, to the central server. In an embodiment, these operations are performed so as to preserve the privacy of respective data that is local to each client.

If, for example, an agent has accumulated a large amount of experience with respect to the operation of the model, it may be beneficial to decrease the ε value, thus increasing the probability that the agent will select the optimal action, concerning the model, based on current estimates. This action, that is, decreasing the ε value, promotes exploitation by the agent and takes advantage of the knowledge acquired by the agent. On the other hand, if the agent has little experience or is performing below the global average for the model, it may be beneficial to increase the value of ε, thus increasing the probability of the agent exploring non-optimal actions and discovering new strategies or regions of the state space that can lead to better results in its local environment.

The server may then analyze the performance of each of the clients, along with the amount of accumulated experience of each client in running the model, and based on the analyzing may dynamically adapt the balance between exploration and exploitation over time. In more detail, the global performance of the federated system in training the model, and a function may be used to adjust the respective client values of ε according to the current situation of each client in relation to the global model.

This function may be evaluated for each client, for k federation training rounds, helping to customize the dynamic adjustment of the ε-greedy for each client according to the individual local performance and the global average performance. The value of k may be linked to the variance of the overall federated learning performance to determine a stopping condition adjusted by the actual training progress, considering the heterogeneity of the local environments and the convergence of the global model.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that the performance of multiple different clients, with respect to training a model may be tuned on an individual client basis. An embodiment may take into account, in the training of a model, the heterogeneity of the environment where the training is performed. Various other advantages of one or more embodiments will be apparent from this disclosure.

### A. Context for an Example Embodiment

Following is a discussion of a context for one example embodiment. This discussion is not intended to limit the scope of the invention in any way.

With reference first to stopping conditions for FRL algorithms, some approaches may employ a fixed number of iterations or a predetermined tolerance limit. Such an approach is easy to implement, however, it can lead to inefficient training and, additionally, it does not consider the specific characteristics of the environments nor the convergence of the global model. It is worth mentioning that RL algorithms should train enough to explore the entire agent environment and find the optimal policy. Concomitantly, training for a long time is likely not efficient because it would increase computation and communication overhead. In other words, it would consume a lot of unnecessary computational and communication resources if the number of training rounds is much higher than necessary to find the optimal policy. This is not easy to infer in a federated environment since, due to the privacy constraints, there is no information about agent environments or local resources. An embodiment may address these circumstances through the definition and use of custom convergence criterion per-client, and per-RL task.

Another aspect of the context for an example embodiment concerns the configuration of the FRL exploitation policy. For example, dynamically tuning ε-greedy in an FRL environment can help enrich the global knowledge of federated clients, as well as decrease the chance of a client getting stuck in a local maximum. This is an important challenge to be overcome to guarantee the wide adoption of FRL and bring more robustness. This is particularly useful in, but not limited to, scenarios where clients are heterogeneous, with limited computational resources and complex RL environments. Typical approaches dynamically adjust the ε-greedy only in a centralized RL, where there is only a single environment under consideration. In contrast, one example embodiment may dynamically adjust the ε-greedy in significantly more complex conditions, namely, federated, heterogeneous, environments with a multitude of clients.

Yet a further aspect of the context for an example embodiment concerns the global model validation environment. Specifically, when evaluating the performance of the global model, it is possible to adopt different strategies for the evaluation. In this case, there is always a trade-off between communication and precision, such as a distributed evaluation, where the global models are sent to the clients, they evaluate the global model in their local environment and then forward the performance metrics to the server. But this approach further burdens federated training, which already suffers from communication issues. Another approach consider an external benchmark as a comparative reference to evaluate the performance of the global model. However, this approach suffers from precision and a lack of reference for some specific tasks. Moreover, this approach may not represent the heterogeneity of clients, and can thus lead to biased results. An embodiment may address these problematic circumstances by creating a less rigid test environment that enables evaluation of the overall performance and generalization of the models in the FRL server more fairly.

As discussed in further detail below, there is presently no known approach that combines these three strategies to enable the global model to adapt to the characteristics and challenges of each client, encouraging the active participation of all clients, and facilitating more generalizable learning in a federated context.

### B. Aspects of FL and FRL

Following is a brief description of various aspects relating to the understanding of one or more problems addressed by an example embodiment. In general, Federated Reinforcement Learning (FRL) is an extension of the Federated Learning (FL) concept that combines FL with Reinforcement Learning (RL). Thus, the next sections define what FL and RL involve, along with their challenges that are inherited by the FRL.

### B.1 Federated Learning

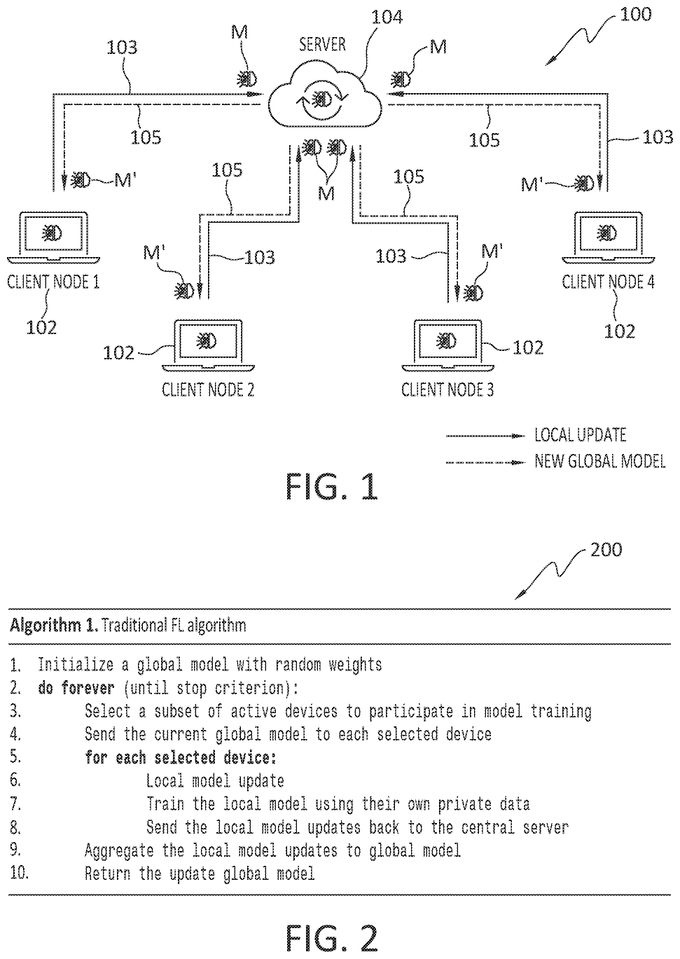

Federated Learning (FL) aims at training models in a collaborative and decentralized way, allowing multiple clients to participate in training without the need to share their private data. In traditional FL, a network architecture considers a central server that coordinates learning between several available clients, as disclosed in the example of FIG. 1. In particular, FIG. 1 discloses an example edge-cloud FL environment 100. Each client 102 trains a model ‘M’ locally with its private data and sends 103 its model parameters to the server 104. The server 104 then combines the contributions of all clients into a global model M′ and sends 105 the updated model M′ to all the 102.

In the configuration disclosed in FIG. 1, remote devices, that is, the clients 102, periodically communicate with a central server, that is, the server 104, to train, and then learn, a global model M/M′. With each round of communication, a subset of selected clients 102 performs local training on their private data and sends these local updates to the server 104. After incorporating the updates, the server 104 pushes back the new global model M′ to another subset of clients 102. This iterative training process, which may be implemented by the algorithm 200 disclosed in FIG. 2, continues through the network until convergence is reached, or some stopping criterion is met.

FL takes a step towards privacy by generating data on each edge device, sharing model updates, for example gradient information, instead of the raw data, which consequently saves bandwidth when compared to centralized ML approaches. Furthermore, FL is highly scalable as it takes advantage of edge devices for distributed training while harnessing collective computing power. Although it presents some challenges, such as dealing with client heterogeneity, privacy guarantees and efficient communication between clients and the server, FL is an attractive solution for applications where privacy and decentralization are priorities.

### B.1.1 Client Heterogeneity

Heterogeneity in federated learning refers to the presence of devices with different respective characteristics that nonetheless cooperatively participate in training, such as training an ML model. The differences among devices can be given by several factors such as computational capacities, data distributions, network connectivity, reliability, among others. Clients with lower computing capabilities may perform slower in the training process. Clients with very different data distributions can make global aggregation difficult by compromising generalization to other distributions. Devices with unstable network connections may have difficulty receiving and sending model updates, which can lead to delays or interruptions in the communication flow. Malicious clients can try to damage the global model or make inferences about the models, compromising privacy. Finally, the heterogeneity of clients in FL must be handled carefully to ensure a robust global model and reliable collaborative learning.

### B.2 Reinforcement Learning

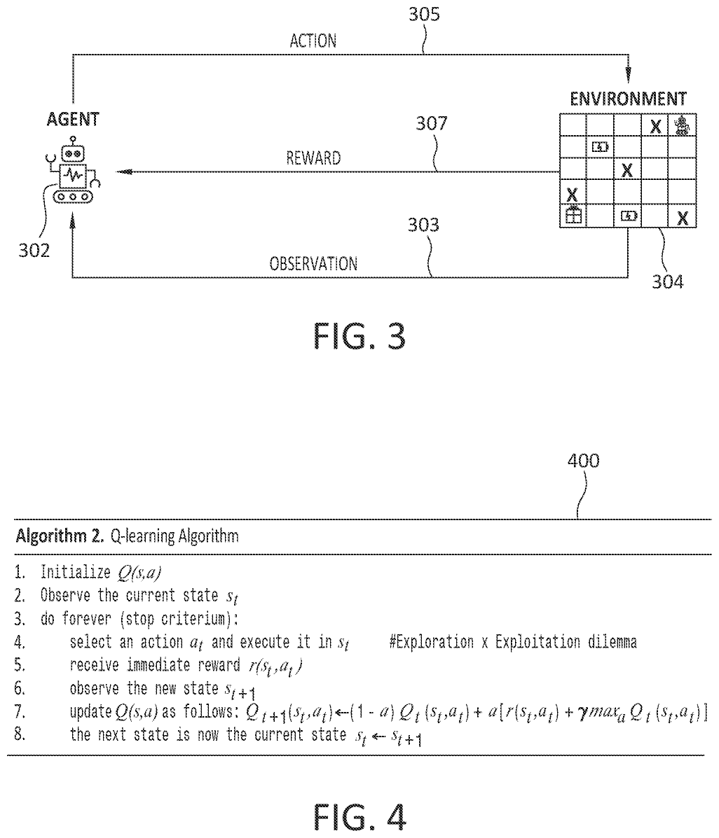

Reinforcement Learning (RL) is a machine learning approach that deals with sequential decision-making. The RL problem may be formalized as an agent, such as may operate at a client, that has to make decisions in an environment to optimize a given notion of cumulative rewards, where the RL agent does not require complete knowledge or control of the environment; it only needs to be able to interact with the environment and collect information. The RL may be formulated as a Markov Decision Process (MDP) problem, where an agent interacts with its environment in the following way: the agent starts, in a given state within its environment s₀∈S, by gathering an initial observation w₀∈Ω; at each time step t, the agent has to take an action aₜ∈A; and, as illustrated in FIG. 3, it follows three consequences, namely, (i) the agent obtains a reward rₜ∈R, (ii) the state sₜ transitions to sₜ₊₁∈S, and (iii) the agent obtains an observation wₜ₊₁∈Ω.

In particular, FIG. 3 discloses a representation of a reinforcement learning task. The agent 302 is the RL component responsible for taking decisions. The agent 302 may comprise any entity capable of perceiving 303 the state of the environment 304, performing actions 305, and receiving feedback 307 in the form of rewards. The environment is the world in which the agent interacts, it defines the rules, restrictions, and dynamics of interactions, in addition to providing feedback to the agent in the form of rewards or penalties.

With reference now to FIG. 4, the Q-learning algorithm 400, that is, a reinforcement learning algorithm, is used to solve RL problems, where the objective is to iteratively learn the optimal Q-value function using the Bellman Optimality Equation. To do this, all Q values are stored in a table that is updated at each step according to the equation (where ‘s’ refers to the state of the environment, and ‘a’ refers to an action taken):

$${Q}_{t + 1} ( {s}_{t} , {a}_{t} ) ← ( 1 - α ) {Q}_{t} ( {s}_{t} , {a}_{t} ) + α [ r ( {s}_{t} , {a}_{t} ) + γ {max}_{a} {Q}_{t} ( {s}_{t} , {a}_{t} ) ] ,$$

where α is the learning rate, an important hyperparameter that controls convergence, and γ is the discount factor that weights the importance of future rewards. During action selections, it is important to take care of the balance between exploration and exploitation to prevent the agent from being pressured into local maxima, or taking suboptimal actions.

In plain terms, and referring to a Q-learning process, an agent may initially be at state zero in an environment. The agent may then take an action, which may be based on a particular strategy. As a result of the action taken, the agent may receive either a reward or penalty based on that action. By learning from previous consequences, that is, reward or penalty, the agent may continue to refine, or optimize, the strategy, until such time as the optimal strategy, or the optimal Q-value function, is found. See, e.g., https://www.datacamp.com/tutorial/introduction-q-learning-beginner-tutorial.

Besides Q-learning, there are other algorithms that may be used to RL problems, for example, A2C (Advantage Actor-Critic), PPO (Proximal Policy Optimization). Each one has its advantages and disadvantages, but the choice of algorithm depends on the specific RL task and the characteristics of the environment in which the agent is operating. RL has been used in a wide variety of applications, including robotics, games, among many others where it is not possible to provide labels, and in very complex and dynamic environments.

### B.2.1 Exploration/Exploitation Dilemma

The exploration-exploitation dilemma is a fundamental challenge in RL. Exploration is about obtaining information of the environment, namely, transition model and reward function, while exploitation is about maximizing the expected return given the current knowledge. As an agent starts accumulating knowledge about its environment, the agent has to deal with a trade-off between learning more about its environment (exploration) or pursuing what seems to be the most promising strategy with the experience gathered so far (exploitation).

One method for balancing exploitation and exploitation is the method called ε-greedy. This method behaves most of the time greedily, but every now and then, with a small probability, it randomly selects one action among all actions.

The purpose of exploration is to gather more information on the part of the search tree where few simulations have been performed, that is, where the expected value has a high variance.

On the other hand, the purpose of exploitation is to refine the expected value of the most promising moves. The agent has to exploit what it has already experienced in order to obtain reward, but it also must explore in order to gather new information—this is the exploration vs exploitation trade-off:

$$ε - greedy : {a}_{t} = \{ \begin{matrix}{a}_{t}^{*} with probability 1 - ε & exploitation \\ random action with probability ε & exploration\end{matrix}$$

Here, a relatively high ε value results in more exploration, and a relatively lower ε value results in more exploitation. However, the value of this probability ε can be static or dynamic. An adaptive approach to the ε-greedy method involves changing the ε value over time, for example by linear or exponential decay, where the ε is initially set to a high value, encouraging intense exploration by the agent and, over time, encouraging the agent to be more cautious and do more exploitation than exploration. These adaptive ε-greedy methods have shown advantages mainly in learning efficiency and adaptability to dynamic environments.

### B.3 Federated Reinforcement Learning (FRL)

Federated Reinforcement Learning (FRL) is an approach from the field of artificial intelligence that combines the concepts of FL and RL discussed earlier herein, in order to be able to train models of RL on distributed devices in a federated way. This is especially useful in scenarios where data is decentralized and cannot be shared due to privacy restrictions. FRL may be divided into two categories, depending on the environment partition, namely, Horizontal Federated Reinforcement Learning (HFRL) and Vertical Federated Reinforcement Learning (VFRL).

In HFRL, an example of which is disclosed in FIG. 500 at 500, the respective environment 502, 504, 506, of each agent 501, 503, and 505, is independent of the others, while the state space, and action space, of different agents may be aligned to solve similar problems. In this case, the action of each agent 501, 503, and 505, only affects the respective environment 502, 504, 506, of that agent 501, 503, and 505, and results in corresponding rewards, or penalties. As an agent is likely unable to explore all states of its environment, multiple agents interacting with their own respective copy of the environment can speed up training and improve model performance by sharing experiences. Thus, horizontal actors, or agents, may use the server (508)-client (510) model to transmit and exchange the gradients or parameters of their policy models (actors) and/or value function models (critics).

In VFRL, multiple agents interact with the same global environment, but each can observe only limited state information within the scope of its view. Agents can perform different actions depending on the observed environment and receive local reward or even no reward.

One example embodiment is particularly concerned with the HFRL scenario, since an aim of one embodiment is to apply RL with geographically distributed agents that face similar decision-making tasks without sharing information with any other. Each participating agent independently performs decision-making actions based on the current state of its respective environment, and obtains positive or negative rewards for evaluation. As the environment explored by an agent is limited and each agent is not willing, or able, to share the collected data, several agents try to train the policy and/or the value model together to improve the model performance and increase the learning efficiency. Thus, a purpose of HFRL is to alleviate the sampling efficiency problem in RL and help each agent to quickly obtain the optimal policy that can maximize the expected cumulative reward for specific tasks, while maintaining privacy protection.

### B.3.1 Problems Inherited from FL and RL

Since FRL combines FL with RL, FRL inherits the challenges of both technologies. One such challenge is the need to deal with the heterogeneity of clients participating in the federation and the balance between exploration/exploitation required by RL problems.

In the context of FRL, each device is involved in its own exploration/exploitation process, taking sequential actions to maximize the cumulative reward in its local environment. However, during federated training, it is necessary to find a balance between the exploitation models of each device and the aggregated global model to achieve optimal overall performance.

Moreover, clients in the FRL can operate in heterogeneous environments, and this can lead to divergences between the local models and the global model, as the global model may not be suitable for all environments. The heterogeneity of agents in FRL refers to differences in policies, learning capabilities and the characteristics and dynamics of the environments in which agents operate.

To deal with this, the FRL requires an adequate exploitation policy to balance the exploration and exploitation of agents during training. But while a proper exploration strategy helps to deal with the heterogeneity of agents, it may not be enough if the diversity among devices/environments is too wide, cases where other added approaches may be needed, such as hierarchical federated learning, knowledge transfer, participant selection of the federation, weight in aggregation, among others.

### C. Overview of an Example Embodiment

One example embodiment is directed to a client-customized ε-greedy adaptive tuning mechanism to improve the balance between exploration and exploitation in FRL applications. In addition, an embodiment may incorporate dynamic metrics validation criteria to measure the distance more fairly between local, and global, policies. This mechanism may help the wide adoption of the FRL by offering decentralized continuous learning services for dynamic and heterogeneous environments such as IoT networks, with privacy guarantees.

In more detail, an embodiment comprises a client-customized ε-greedy adaptive adjustment mechanism that considers the performance of each client in an environment that comprises multiple clients. In this case, the goal is to encourage clients to better explore their respective environments while evaluating the overall performance of the federation to guarantee the federated system optimization.

To provide information about the performance of the clients, each client may locally store some metrics for each completed episode, the metrics may be any metric useful for the RL task, for example, average time to complete episodes, and accumulated reward, and these metrics may be sent, along with the local model parameters, by the clients to the server. In this case, this procedure may be done with guarantees of DP (differential privacy) to avoid potential security and privacy threats in scenarios with malicious clients. As such, if an agent has accumulated a large amount of experience, it may be beneficial to decrease the ε value, thus increasing the probability of the agent selecting the optimal action based on current estimates. This action promotes exploitation and takes advantage of the knowledge acquired by the agent. On the other hand, if the agent has little experience, or is performing below the global average, it may be beneficial to increase the value of, thus increasing the probability of the agent exploring non-optimal actions and discovering new strategies or regions of the state space that can lead to better results in its environment.

Next, the FL server may analyze the respective local performance of each client, and the amount of experience accumulated by that client, and dynamically adapt the balance between exploration and exploitation over time. An example embodiment may use the global performance of the federated system and a function to adjust the value of ε according to the current situation of each client in relation to the global model.

This function may be evaluated for each client for k federation training rounds, helping to customize the dynamic adjustment of the ε-greedy for each client according to [1] the individual local performance and [2] the global average performance, which is beneficial mainly in scenarios where federated clients operate under limited computational resources and/or in very complex and heterogeneous environments. The value of k may be linked to the variance of the overall federated learning performance to determine a stopping condition adjusted by the actual training progress, considering the heterogeneity of the local environments and the convergence of the global model.

As will be apparent from this disclosure then, example embodiments may possess various useful aspects and features, although no embodiment is required to possess any of these aspects and features.

In general, considering the aforementioned procedures of an embodiment of a client-customized ε-greedy adaptive adjustment mechanism, the server is able to adjust this balance between exploration and exploitation in a customized fashion for each client without failing to consider the heterogeneity of the environments and the computational resources of the clients to find the ideal configuration that optimizes the global performance of the federated system. This is a new adaptive mechanism to adequately deal with the challenges of FRL scenarios in dynamic and/or heterogeneous environments.

More specifically, the following items are examples of aspects and features of one or more example embodiments:
1. a dynamic policy convergence threshold as a stopping condition for FRL algorithms;
2. a client-customized ε-greedy adaptive tuning mechanism that considers client performance and accumulated experience; and
3. performance evaluation of the global model over a dynamic representative environment.

### D. Detailed Discussion of Aspects of an Example Embodiment

An example embodiment deals with an FRL scenario, in which heterogeneous clients act as agents that need to learn an optimal policy over a local dynamic environment, but at the same time contribute to the optimization of a global policy generalizable to other similar environments. An embodiment thus comprises an appropriate exploration strategy to ensure that all agents have the opportunity to explore the environment and collect relevant information.

In extreme cases of heterogeneity, an embodiment may be supplemented with complementary approaches to guarantee coherence between (a) the learned policies and (b) the convergence of the learning of an optimal global policy. Also, this algorithm does not disregard the use of other strategies such as the selection of clients based on some specific criteria, such as the consumption of computational or communication resources for example, or the weighted aggregation of local contributions during the global model update, among others. These strategies may together help an FRL process converge to an optimal global policy.

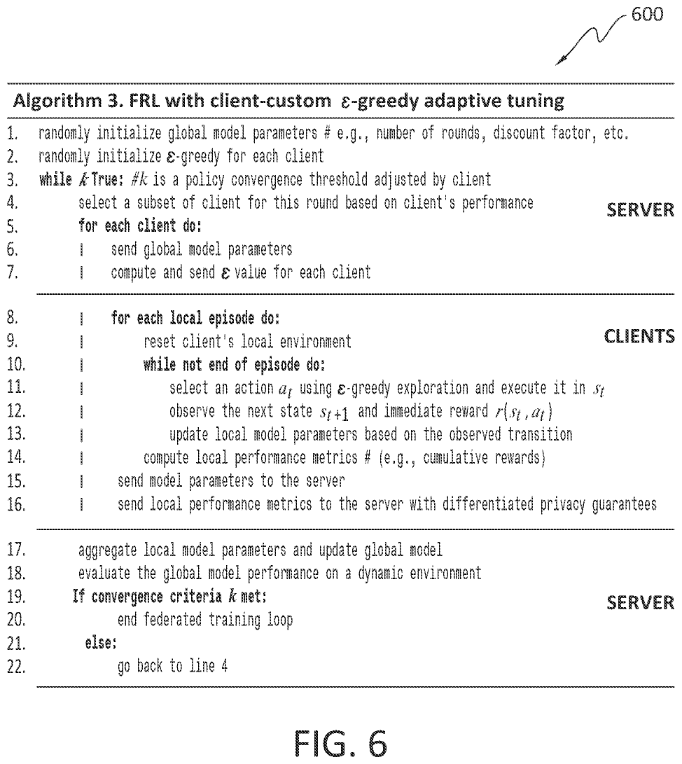

One example embodiment combines three strategies to help the global model adapt to the local characteristics of each different client environment, encouraging the active participation of all and facilitating more generalizable learning in a dynamic and heterogeneous federated context. The example algorithm 600 in FIG. 6 comprises the training loop of an example FRL according to an embodiment, with particular attention being directed to the respective operations at lines 3, 7, and 18, each of which is discussed in further detail below.

### D.1 Client-Custom Policy Convergence Threshold

One example embodiment employs a convergence criterion that evaluates [1] the reward rates accumulated by clients and [2] the average task completion times of the local and global models. For this, an embodiment may evaluate whether the divergence between these metrics [1] and [2] is greater than a limit k.

To define this limit k, an embodiment may evaluate the metrics on the global model at each iteration on n different environments. In an embodiment, this number of environments may be defined as greater than or equal to the number of clients participating in the federation, to better represent the different environments they may have. Of course, this does not guarantee that all of the clients are represented, but they are evaluated more fairly than if they were evaluated on a single environment.

After the limit k has been defined, during the federated training, an embodiment may follow the individual convergence of each client and check the average convergence of the global model. For this, an embodiment may monitor the performance metrics of the clients at each training cycle with DP (differential privacy) guarantee and use the global average as a reference to define the convergence limit for each client. An embodiment may use a weighted combined convergence, which evaluates the cumulative reward kᵣ per unit of average task completion time kₜ. This combination may thus provide a measure that considers both performance in terms of success in executing the tasks, as well as the efficiency or time taken to complete the task.

In this case, the threshold is k=αkᵣ/βkₜ, where α and β are variables that weigh the importance of metrics according to the requirements and goals of the specific FRL application. The value of k is given by the average performance of the global model evaluated over the n different environments. Thus, if all clients have an efficiency greater than or equal to some % of k, it means that all clients have converged and, with them, the global model as well.

This threshold percentage value can be adjusted for each client according to the need for strong convergence in a given application. Clients with limited resources may have a lower % to ensure they can participate in federation. At the same time, this k-value can be used to select the most efficient customers, or to weigh their contributions during the aggregation phase of the model. In one embodiment, k is evaluated this way, but that does not prevent it from being adapted to the FRL task requirements, considering other metrics for example.

### D.2 Client-Custom ε-Greedy Tuning

The adaptive tuning mechanism according to one embodiment may adapt the exploration rate ε individually for each client during distributed training. This may be especially useful to optimize the overall performance in scenarios where the FRL agent acts on heterogeneous and/or dynamic environments. The intuition behind this approach is to adjust the ε of each client based on the amount of experience acquired. Applying this strategy, an embodiment may achieve greater efficiency and flexibility in the FRL, allowing the applications to adapt to different scenarios and changes in the distribution of local client environment.

At the beginning of federated training, a random ε value may be initially set by the server for each client. Then, each client undergoes local training for a certain time, possibly using an early stopping condition, and gains experience, choosing actions according to the ε value, which decreases over time.

At the end of a federation training cycle, the server evaluates the performance acquired by clients for that ε and calculates a new value for the next federated training cycle influenced by the global model performance. If the agent has accumulated a large amount of experience, it may be beneficial to decrease the value of ε for that agent, thus increasing the probability of that agent selecting the optimal action based on current estimates. This action promotes exploitation, and takes advantage of the knowledge acquired by the agent. If the agent has little experience or performs below the global average, it can be beneficial to increase the value of ε for that agent, thus increasing the probability of that agent exploring non-optimal actions and discovering new strategies or regions of the state space that can lead to better results in its environment.

In this context, a server may use a sigmoidal function to determine the value of ε as follows:

$$ε = \frac{1}{1 + {e}^{- z ( {Z}_{p} - {C}_{p} )}} ,$$

where Cₚ represents the client performance in its local environment, Sₚ is the average performance of the global model evaluated over n test environments, and z is a tuning parameter that controls the slope of the sigmoidal curve and adjusts how sensitive the function is to differences in performance, and may be adjusted according to the sensitivity desired by the specific context of the FRL task.

Following the determination of the value(s) of ε, the server may assign a higher value of ε to clients whose local performance is lower than the global performance, thus encouraging those client to explore more, and a smaller ε to clients with local performance equal to or greater than the global performance, thus encouraging those clients to do more exploitation. The tendency is that, at each training cycle, the value of ε of each client may decrease according to the average performance of the global model and not only considering its local environment, and then reach a better global convergence.

In an embodiment, the local Cₚ and global Sₚ performance measures may be adapted according to the FRL problem, for example, if it is a game, it can be considered as a weighted average of the experiences, time, and rewards, accumulated per episode. This is usually a measure that combines task execution time, and the quality or efficiency of actions taken by agents, to obtain a more comprehensive performance assessment.

This client-custom ε-greedy tuning, together with the convergence stop condition evaluated in the previous section, offer greater guarantees of balance between exploration and exploitation of unknown local environments with a better adaptation to the heterogeneity of the clients and greater efficiency in the federated learning process. However, it usually necessary to adapt them to the specific RL task at hand.

### D.3 Global Model Evaluation on a Dynamic Representative Environment

An approach according to one embodiment creates a less rigid test environment that allows evaluating the overall performance and generalization of the models on the FRL server more fairly. For this, an embodiment may create at least n different synthetic environments that are as different as the diversity of the local performance values provided by the n clients in the previous steps.

By analyzing the performance metrics of the clients, the server may infer the diversity of the client training environments and try to reproduce this in the test environment. This magnitude of diversity may, in an embodiment, be calculated with some measure of distance such as Euclidean distance for example, or divergence such as Kullback-Leibler divergence for example, among others.

Evaluating the global model in various environments enables checking its average performance in different contexts, providing a broader view of its generalization capacity, and reducing the bias associated with a specific environment, thus obtaining a fairer and more balanced evaluation. Lastly, it is apparent that this approach may be valid only when looking for a global model without focus on a specific behavior and more generalizable for several different clients, otherwise the ideal is to test on a fixed environment representative of the context in which greater adaptability is desired.

### E. Example Use Case

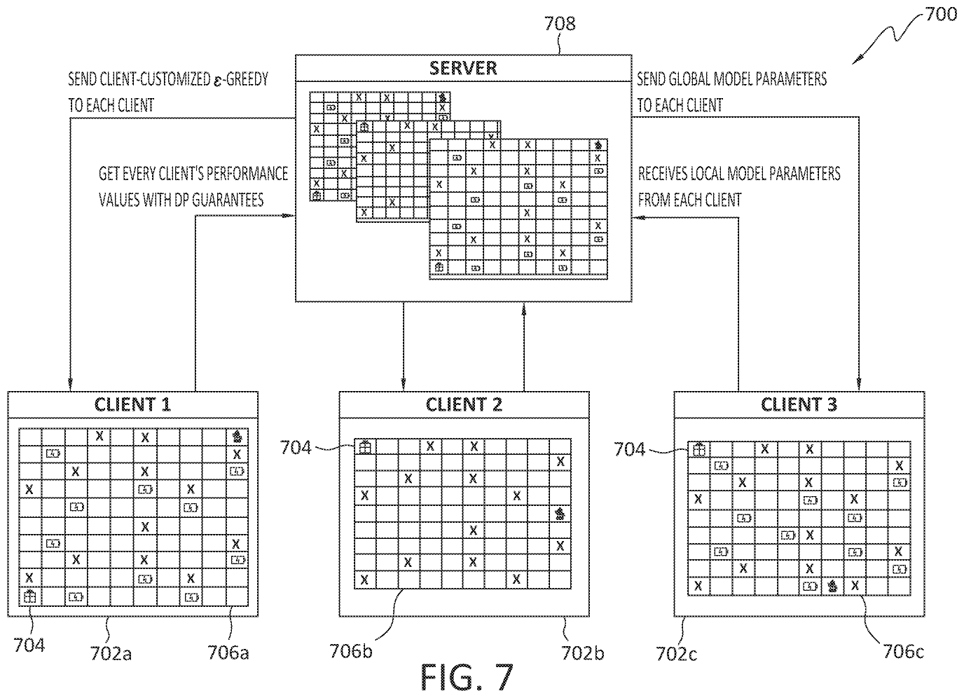

Reference is now made to an example use case disclosed in FIG. 7, which represents a FRL environment 700 with three clients 702a, 702b, and 702c, whose common task is to teach a robot 704 to cross a respective environment 706a, 706b, and 706c, such as a labyrinth for example, where there are some rewards along the way but also some obstacles. The optimal policy corresponds to finding the path that [1] gets from the start point to the goal point fastest, but with [2] the highest accumulated reward.

Thus, of these clients 702a, 702b, and 702c trains its robot 704 on a different respective environment 706a, 706b, and 706c. As shown in FIG. 7, the environments 706a, 706b, and 706c are diverse in size, number of obstacles, amounts of rewards and positions of obstacles, rewards starting position and final goal. The possible actions of the robot (agent) are only 4, namely, up, down, left and right, and the space of states depends on the dimensions of the environment 706a, 706b, and 706c, for example, the number of columns times the number of rows of the grid depicted in FIG. 7.

An embodiment may employ a Q-Learning algorithm and a neural network of two linear layers separated by a ReLU activation function to learn the Q function. At the beginning of federated training, this MLP (multi-layer perceptron) may be initialized with random values, like the ε values, and sent to each client. From that point on, clients start training on their local environments by choosing actions according to the assigned random ε.

As the training progresses, clients will decrease their ε value and will acquire experience in that environment. This local training may continue until some stopping condition is met, usually related to time on devices with limited resources, or some early stopping convergence condition. At that point, it may be that the trained model has acquired the optimal reward if two things are accomplished. First, if the previously defined ε was large enough to explore the local environment completely avoiding being trapped in a local maximum. And second, if the stopping condition was enough for the training to reach local convergence.

However, if this is true, it may still be difficult for the global model to be optimized for all clients, especially in scenarios with heterogeneous clients. After that, the clients send the parameters of the Q values models to the server, and together with those, the clients send performance information computed during the training episodes, for example, experience, average task completion time, and accumulated reward, with DP mechanism for not compromising client privacy. Next, the server receives the model parameters from the clients and aggregates them using a classic FL algorithm such as FedAvg, disclosed in “SUN, Tao; LI, Dongsheng; WANG, Bao. Decentralized federated averaging. IEEE Transactions on Pattern Analysis and Machine Intelligence, 2022, vol. 45, no 4, p. 4289-4301,” which is incorporated herein in its entirety by this reference.

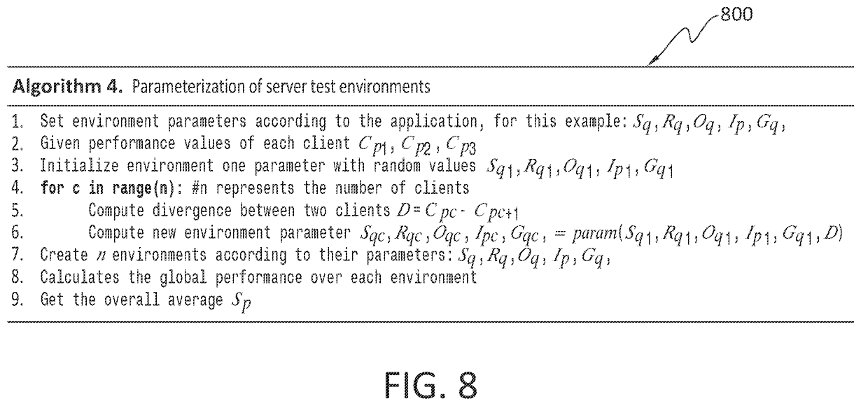

In the use case scenario of FIG. 7, the server 708 creates 3 different test environments to get the average performance of the global model Sₚ. Differences between test environments are equivalent to differences in the respective client performances. For this the server executes the example algorithm 800 disclosed in FIG. 8.

In this example algorithm 800, the parameters S_{q}, R_{q}, O_{g}, Iₚ, G_{q} mean, respectively, the number of states, midway rewards, midway obstacles, the starting point, and the goal point. The parameters should comply with some restrictions—for example the values of Iₚ and Gₚ must be normalized between 1 and the number of states S_{q}, to fall within the grid and, as well, no parameter can occupy the same position, nor can their sum be greater than the number of possible states R_{q}+O_{q}+2<S_{q}, where the number 2 reserves the starting and ending positions of the environment 706a/b/c. After that, the server may then possess the parameters of n different environments, and can create those environments.

The server may then evaluate the overall model on top of it and calculate the performance average Sₚ. The server may not remove DP from client data to prevent malicious clients from generating inferences about client data and compromising client privacy.

A new stop condition given by k=αkᵣ/βkₜ may be evaluated for each client—if all the clients have a k_{client}≥k, the federated training ends, otherwise the training continues until k_{client}≥k, is reached by all clients. In this case, an embodiment may consider the α and β parameters to be of equal importance because time and reward are equally weighted in this example.

Next, the server 708 may evaluate the expression:

$$ε = \frac{1}{1 + {e}^{- z ( {Z}_{p} - {C}_{p} )}} ,$$

and determine the ε value for each client 702a/b/c. The performance measures can be anything that is interesting for the RL task problem, such as average time of episodes, accumulated reward, and experience, for example, but to calculate the ε, an embodiment may make sure that the same ones are used on the clients Cₚ and on the server Sₚ to avoid inconsistency. The z is an adjustment factor that weighs the importance of the difference between the server 708 and client 702a/b/c performances and must be adjusted according to the sensitivity that the FRL task imposes. Then:

$$if {S}_{p} > {C}_{p} \to 1 + {e}^{- z ( {S}_{p} - {C}_{p} )} ↓ \to ε ↑ more exploration$$

the greater Sₚ than Cₚ, the greater of a value, encouraging the client to explore further. This comes from the intuition that clients with performance metrics far below the global average have not found the optimal policy for their environment. In a new round of training with a higher ε value, it can help to explore more the local environment according to the updated local model.

On the other hand, if:

$$if {S}_{p} < {C}_{p} \to 1 + {e}^{- z ( {S}_{p} - {C}_{p} )} ↑ \to ε ↓ more exploitation$$

in the case that clients perform above average, they will be encouraged to do more exploitation to reinforce the acquired knowledge.

Thus, the server handles the balancing of the exploration and exploitation rates of each client according to the global model performance, seeking that all converge to an optimal global policy. To implement this use case, the Flower framework (BEUTEL, Daniel J., et al. Flower: A friendly federated learning research framework. arXiv preprint arXiv:2007.14390, 2020—incorporated herein in its entirety by this reference), together with Pytorch libraries, are well suited candidates.

### F. Example Methods

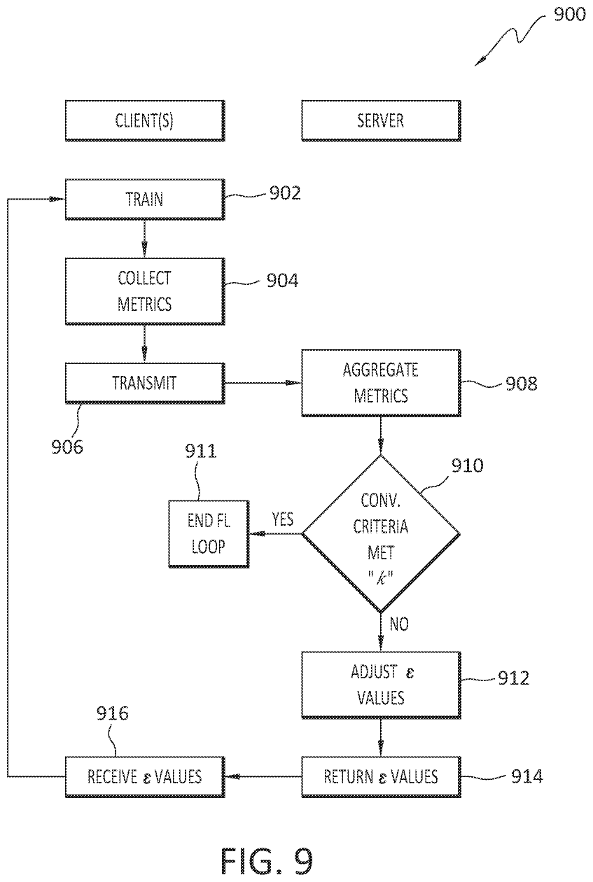

It is noted with respect to the disclosed methods, including the example method of FIG. 9, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 9, a method 900 is disclosed according to one example embodiment. As shown, the method 900 may be cooperatively performed by and between one or more clients and/or their respective agents, and a server. The method 900 may begin with an initial training round 902, such as the training of an ML model for example. As a result of the training, various parameters and metrics may be generated that are collected by the agent 904. The parameters and metrics may then be transmitted 906 to the server.

The server may aggregate 908 all the metrics and parameters received from all the clients. If the server determines 910 that a convergence criterion ‘k’ has been met, the federated learning loop may end 911. If, on the other hand, the server determines 910 that the convergence criterion ‘k’ has not been met, the method 900 may advance to 912 where the server computes respective updated ε values for each of the clients. Note that, prior to commencement of the training 902, the server may randomly select ε values for each of the clients, which may then be adjusted, as/if necessary, as shown at 912. The adjusted ε values may then be returned 914 to the clients.

After receipt 916 of the ε values, the clients may perform another round of training, returning to 902. The updated ε values may guide the clients in the training process. For example, the extent to which exploitation and/or exploration is performed by the clients in the next training round may be a function of the respective ε values.

### G. Further Example Embodiments

Following are some further example embodiments of the invention. These are presented only by way of example and are not intended to limit the scope of the invention in any way.

Embodiment 1. A method, comprising: receiving, by a server from each client in a group of clients, metrics and parameters of local models relating to training of a model by the client; aggregating, by the server, the model parameters; determining, by the server using the metrics that have been sent, if a convergence criterion for the model has been met, and when the convergence criterion is determined not to have been met, calculating, by the server, a respective ε value for each of the clients; and transmitting, by the server to the clients, the respective ε values, and the ε values respectively indicate, to the clients, an extent to which the client should perform exploration, and/or exploitation, in a next training round for the model.

Embodiment 2. The method as recited in any preceding embodiment, wherein the clients in the group of clients are heterogeneous.

Embodiment 3. The method as recited in any preceding embodiment, wherein when the convergence criterion is determined to have been met, no further training rounds are performed.

Embodiment 4. The method as recited in any preceding embodiment, wherein each of the ε values is client-specific.

Embodiment 5. The method as recited in any preceding embodiment, wherein when the convergence criterion is determined to have been met, the model is deemed optimal from perspectives of individuals of the clients involved in training the model, and from a perspective of a global environment in which the clients are deployed.

Embodiment 6. The method as recited in any preceding embodiment, wherein the server uses the metrics to update the model, and the server sends the model to the clients after the model has been updated.

Embodiment 7. The method as recited in any preceding embodiment, wherein the group of clients is a subset of all clients in an environment that includes the group of clients and the server.

Embodiment 8. The method as recited in any preceding embodiment, wherein, prior to any training, the server randomly generates initial respective ε values for the clients.

Embodiment 9. The method as recited in any preceding embodiment, wherein the server increases the ε value for one of the clients whose performance in the training is lower than a global performance in training the model, and the server decreases the ε value for one of the clients whose performance in the training is greater than a global performance in training the model.

Embodiment 10. The method as recited in any preceding embodiment, wherein the convergence criterion is a k value.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

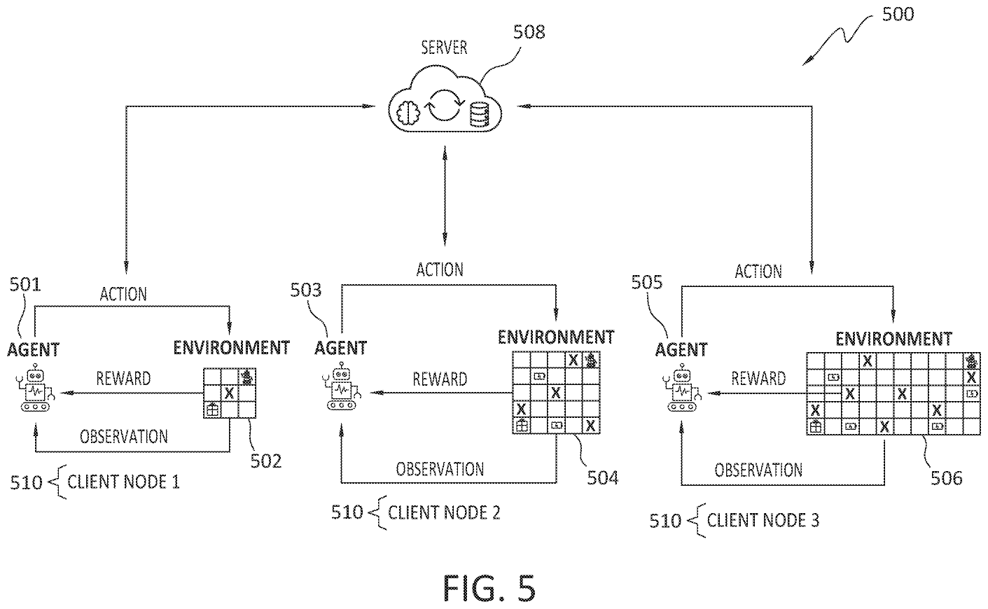

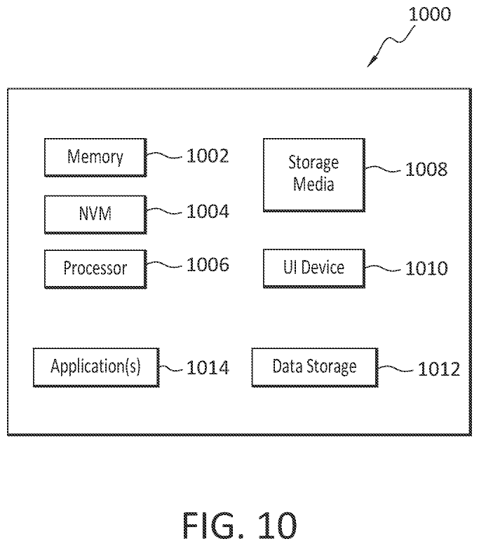

With reference briefly now to FIG. 10, any one or more of the entities disclosed, or implied, by FIGS. 1-9, and/or elsewhere herein, may take the form of, or include, or be implemented on, or hosted by, a physical computing device, one example of which is denoted at 1000. As well, where any of the aforementioned elements comprise or consist of a virtual machine (VM), that VM may constitute a virtualization of any combination of the physical components disclosed in FIG. 10.

In the example of FIG. 10, the physical computing device 1000 includes a memory 1002 which may include one, some, or all, of random access memory (RAM), non-volatile memory (NVM) 1004 such as NVRAM for example, read-only memory (ROM), and persistent memory, one or more hardware processors 1006, non-transitory storage media 1008, UI device 1010, and data storage 1012. One or more of the memory components 1002 of the physical computing device 1000 may take the form of solid state device (SSD) storage. As well, one or more applications 1014 may be provided that comprise instructions executable by one or more hardware processors 1006 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, by a server from each client in a group of clients, metrics and parameters of local models relating to training of a model by the client;
aggregating, by the server, the model parameters;
determining, by the server using the metrics that have been sent, if a convergence criterion for the model has been met, and when the convergence criterion is determined not to have been met, calculating, by the server, a respective ε value for each of the clients; and
transmitting, by the server to the clients, the respective ε values, and the ε values respectively indicate, to the clients, an extent to which the client should perform exploration, and/or exploitation, in a next training round for the model.

2. The method as recited in claim 1, wherein the clients in the group of clients are heterogeneous.

3. The method as recited in claim 1, wherein when the convergence criterion is determined to have been met, no further training rounds are performed.

4. The method as recited in claim 1, wherein each of the ε values is client-specific.

5. The method as recited in claim 1, wherein when the convergence criterion is determined to have been met, the model is deemed optimal from perspectives of individuals of the clients involved in training the model, and from a perspective of a global environment in which the clients are deployed.

6. The method as recited in claim 1, wherein the server uses the metrics to update the model, and the server sends the model to the clients after the model has been updated.

7. The method as recited in claim 1, wherein the group of clients is a subset of all clients in an environment that includes the group of clients and the server.

8. The method as recited in claim 1, wherein, prior to any training, the server randomly generates initial respective ε values for the clients.

9. The method as recited in claim 1, wherein the server increases the ε value for one of the clients whose performance in the training is lower than a global performance in training the model, and the server decreases the ε value for one of the clients whose performance in the training is greater than a global performance in training the model.

10. The method as recited in claim 1, wherein the convergence criterion is a k value.

11. A non-transitory storage medium having stored therein instructions that are executable by one or more hardware processors to perform operations comprising:
receiving, by a server from each client in a group of clients, metrics and parameters of local models relating to training of a model by the client;
aggregating, by the server, the model parameters;
determining, by the server using the metrics that have been sent, if a convergence criterion for the model has been met, and when the convergence criterion is determined not to have been met, calculating, by the server, a respective ε value for each of the clients; and
transmitting, by the server to the clients, the respective ε values, and the ε values respectively indicate, to the clients, an extent to which the client should perform exploration, and/or exploitation, in a next training round for the model.

12. The non-transitory storage medium as recited in claim 11, wherein the clients in the group of clients are heterogeneous.

13. The non-transitory storage medium as recited in claim 11, wherein when the convergence criterion is determined to have been met, no further training rounds are performed.

14. The non-transitory storage medium as recited in claim 11, wherein each of the ε values is client-specific.

15. The non-transitory storage medium as recited in claim 11, wherein when the convergence criterion is determined to have been met, the model is deemed optimal from perspectives of individuals of the clients involved in training the model, and from a perspective of a global environment in which the clients are deployed.

16. The non-transitory storage medium as recited in claim 11, wherein the server uses the metrics to update the model, and the server sends the model to the clients after the model has been updated.

17. The non-transitory storage medium as recited in claim 11, wherein the group of clients is a subset of all clients in an environment that includes the group of clients and the server.

18. The non-transitory storage medium as recited in claim 11, wherein, prior to any training, the server randomly generates initial respective ε values for the clients.

19. The non-transitory storage medium as recited in claim 11, wherein the server increases the ε value for one of the clients whose performance in the training is lower than a global performance in training the model, and the server decreases the ε value for one of the clients whose performance in the training is greater than a global performance in training the model.

20. The non-transitory storage medium as recited in claim 11, wherein the convergence criterion is a k value.
